(19) United States
(12) Patent Application Publication
(10) Pub. No.: US 2006/0250352 A1
(43) Pub. Date: Nov. 9, 2006

(54) System and method for improved cursor functionality

(75) Inventors: James R. Fairs, Naperville, IL (US); Vlad Zarney, Calabasas, CA (US)

Correspondence Address: Fernandez & Associates, LLP, PO Box D, Menlo Park, CA, 94025-6204, US

(73) Assignee: Mice Technoligies, Inc., Naperville, IL (US)

(21) Appl. No.: 11/123,934

(22) Filed: May 5, 2005

(51) Int. Cl. G09G 5/00

(52) U.S. Cl. 345/156

(57) ABSTRACT

Three implementations of a novel method for improved cursor functionality are described: “Instant Navigator”, “Grid”, and “Phantom Cursor”. In “Instant Navigator”, two menu bars are generated for fast and easy access to various applications and actions within a certain application. In “Grid”, cursor moves along a grid line, e.g. only along the vertical and the horizontal directions. In “Phantom Cursor”, objects surrounding the system cursor are selected and highlighted as if there is a second cursor. These inventions will increase the speed of computation and execution greatly. Another implementation of a novel method for generating tagged windows mouse messages is described herein. Such tagged windows mouse messages are coupled with a cursor rendering application to generate second, third, or more independent cursors or control points.

### BACKGROUND

1. Field of the Invention

The invention relates generally to an interface for graphical input devices and control points and, more specifically, the teaching in accordance with this invention relates to systems and methods for improved cursor functionality.

2. Related Art

Cursors and control points are used in a user interface to point to a desired specific position, and to allow users to input data. Conventionally, cursors and control points are allowed to move freely within a user interface. Usually, only limited functionality is associated with cursors and control points, or is associated with the movements of cursors and control points. In many environments, and under certain circumstances, it is desirable to have additional functions associated with cursors and control points or, more specifically, associated with the movements of cursors and control points.

As should be apparent, there is a need for providing improved functionality that associates with cursors and control points. There is also a need to provide faster and easier access to data input using improved functionality. The goal of this invention is to overcome the limitations and boundaries of traditional cursors and control points. Novel methods and systems supporting such a system are described herein.

### SUMMARY

Methods for improved cursor functionality are disclosed. A controller comprising processors, memories, graphical input interface, and low-level mouse hook is described herein in the present invention. Three embodiments are disclosed in detail. The first embodiment comprises a subroutine residing in low-level mouse hook, which generates an interface for providing shortcuts to application programs and actions. The second embodiment comprises a subroutine residing in a low-level mouse hook, which generates an interface for restricting the movement of a cursor or control point to a pre-defined grid line. The third embodiment comprises a routine residing in a low-level mouse hook, which generates an interface for selecting and highlighting objects surrounding a cursor or control point within a pre-selected definition. The fourth embodiment comprises a routine residing in a low-level mouse hook to generate tagged window mouse messages which, in turn, are used as inputs for a single or a plurality of cursor-rendering applications.

This summary does not purport to define the invention. The invention is defined by the claims.

### BRIEF DESCRIPTION OF THE DRAWINGS

FIG. 1 is a block diagram of a cursor functionality system suitable for practicing the present invention;

FIG. 2 is a cursor functionality system according to one exemplary implementation of the present invention (Instant Navigator application);

FIG. 3 is a diagrammatic illustration of an application menu according to one exemplary implementation of the present invention (Instant Navigator application);

FIG. 4 is a diagrammatic illustration of a context menu according to one exemplary implementation of the present invention (Instant Navigator application);

FIG. 5 is a cursor functionality system according to another exemplary implementation of the present invention (Grid application);

FIG. 6 is a diagrammatic illustration of an exemplary pre-defined grid line;

FIG. 7 is a cursor functionality system according to another exemplary implementation of the present invention (Phantom Cursor application);

FIG. 8 is a cursor functionality system according to another exemplary implementation of the present invention (tagged window message application);

FIG. 9 lists some examples of tagged window messages.

### DETAILED DESCRIPTION

In the following description, reference is made to the accompanying drawings which form a part hereof, and which show, by way of illustration, a preferred embodiment of the present invention. It is understood that other embodiments may be utilized and structural changes may be made without departing from the scope of the present invention. The following detailed description of the preferred embodiment presents a specific embodiment of the present invention. However, the present invention can be embodied in a multitude of different ways as will be defined and covered by the claims.

This specification describes a system for implementing novel functionality associated with cursors or control points. The system described herein installs subroutines in a single or a plurality of low-level mouse hooks to monitor the mouse messages and to instruct listening applications to respond to the movement of cursors and control points. Examples of such responses include, but are not limited to, the availability of context menus, application menus, cursor movements restricted to pre-defined formats, or the creation of control over several actions simultaneously using the same cursor. Functionality resulting from these responses greatly enhances the speed and convenience in data input.

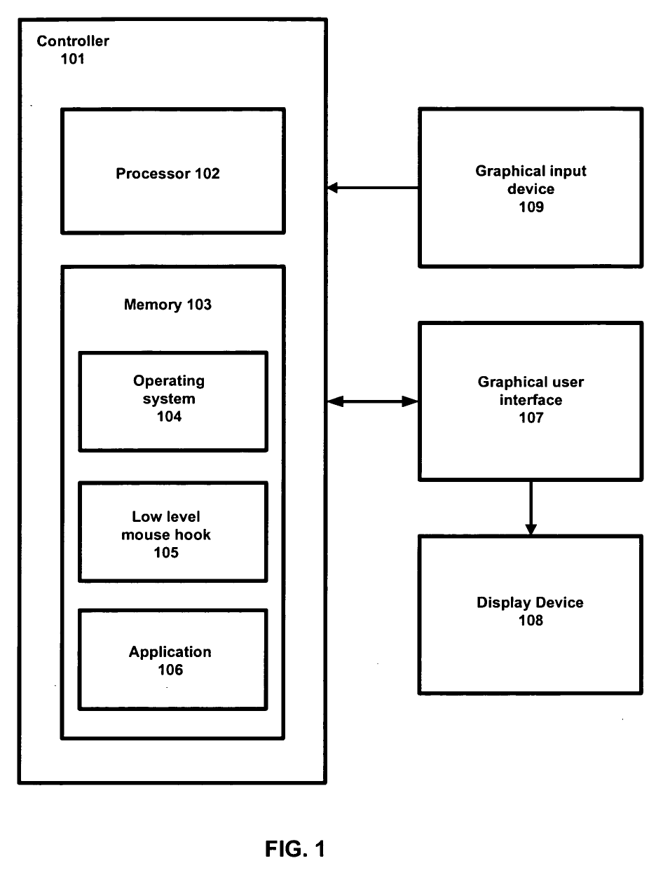

Referring to FIG. 1, a block diagram of a cursor functionality system suitable for practicing the present invention will be discussed and described. A cursor functionality system for implementing cursor functionality comprises a controller 101. The controller 101 further comprises a processor 102 for executing software functions. The controller further comprises memory 103 for storing operating system instructions 104, low-level mouse hook subroutine instruction 105, and applications 106. The system further comprises a graphical user interface 107. The graphical user interface 107 is coupled with a single or a plurality of display devices 108. The system further comprises a single or a plurality of graphical input devices 109. As understood herein, the term “graphical input devices” are interpreted and construed broadly to mean any input device or any input functionality, software, hardware, or firmware, which generates continuous or discrete input signal based on human manipulation. It would be obvious to a person skilled in the art that such graphical input devices comprise any graphical, electronic, or sonic input device. Examples of such graphical input devices include, but are not limited to, standard mice, modified mice, touch screens, drawing pads, game controllers, joysticks, multiple touch screens, touch pads, keyboards, and voice driven input systems, as well as various firmware, etc. Examples of memory 103 include, but are not limited to, magnetic tapes, magnetic drums, magnetic disks, CDs, optical storage, RAM, ROM, EEPROM, EPROM, flash memory, or any other suitable storage media. Memory 103 may be fixed or removable. Graphical input devices 109 may be connected to controller 101 via serial port, USB port, or PS/2 port, or other connection types. Graphical input devices 109 may be connected to controller 101 via wire, IR, wireless, or remotely, such as over the Internet, and other means. The methods described herein are best facilitated in software code installed and operated on a processor 102 as part of the operating system 104, low level mouse hook 105, or an application 106. The development of the code, given the instructions herein, requires ordinary skill in the art and is easily accomplished by software developers or programmers of ordinary skill.

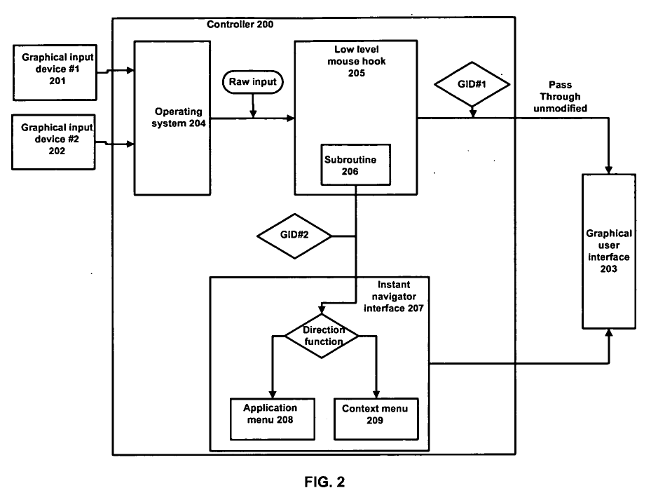

Turning now to FIG. 2, a cursor functionality system is illustrated in block diagram according to one exemplary implementation of the present invention. According to this embodiment, a cursor functionality system comprising two graphical input devices is illustrated in the figure herein. However, the system and method described for the invention is not limited to a system with two graphical input devices. On the contrary, the invention is intended to cover an interface system utilizing a single or a plurality of graphical input devices, as illustrated in FIG. 2: a cursor functionality system comprising controller 200, graphical input device #1 201, graphical input device #2 202, and graphical user interface 203. Controller 200 accepts inputs from graphical input device # 1 201 and graphical input device #2 202. Operating system 204 generates raw input and passes raw input to low-level mouse hook 205. Subroutine 206, within low-level mouse hook 205, monitors raw input message. Subroutine 206 determines which graphical input device generates the raw input message. If, for example, the raw input message is generated by graphical input device #1 201, it will pass through unmodified, and reaches the target window procedure, it will be used to generate a cursor or control point via the graphical user interface 203. If subroutine 206 determines that the raw input message is generated by graphical input device #2 202, subroutine 206 calls a direction function and generates Instant Navigator interface 209 via graphical user interface 203. Depending on the direction of the movements of graphical input device #2 202, subroutine 206 instructs different responses and procedures under Instant Navigator interface 209. According to the embodiment illustrated in FIG. 2, an application menu 208 is generated if the direction is determined to be dominantly horizontal (left-right). A context menu 209 is generated if the direction is determined to be dominantly vertical (up-down). It would be obvious to a person skilled in the art that other pre-defined directions could be adopted for application menu 208 or context menu 209.

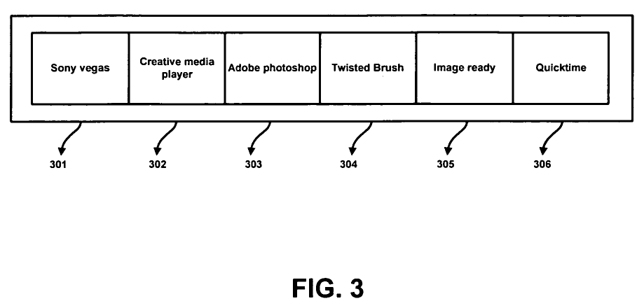

FIG. 3 is a diagrammatic illustration of an application menu 208 according to one exemplary implementation of the present invention. As shown in FIG. 3, application menu 208 provides a shortcut to various application programs. When graphical input device moves to specific application program shortcut and clicks the application program, the application program is highlighted and the application program opens. Preferably, application menu 208 contains all selected active applications on graphical display. Optimally, application menu 208 could be pre-defined by users. An example of application menu 208 is shown in FIG. 3 comprising shortcuts to Sony Vegas 301, Creative Media player 302, Adobe Photoshop 303, Twisted Brush 304, Image Ready 305, and QuickTime 306.

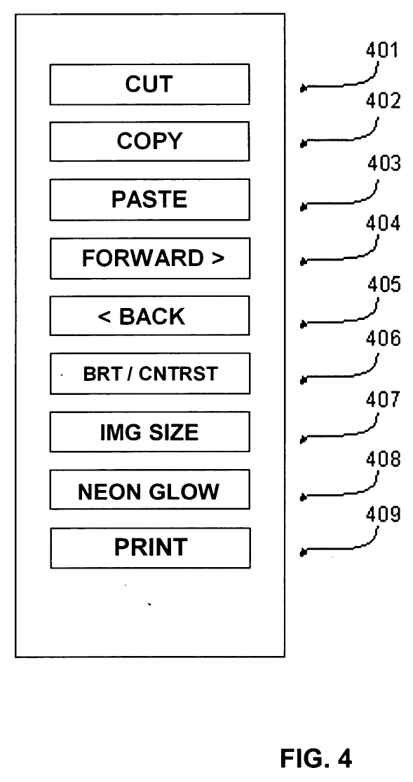

FIG. 4 is a diagrammatic illustration of a context menu 209 according to one exemplary implementation of the present invention. As shown in FIG. 4, the context menu provides a shortcut to various actions to be preformed within an application program in use. When graphical input device moves to specific action shortcut within an application program and clicks the action icon, the action is activated. Preferably, the context menu contains user pre-defined actions. An example of context menu is shown in FIG. 4 comprising shortcuts to actions within Adobe Photoshop: cut 401, copy 402, paste 403, forward>404, <back 405, etc.

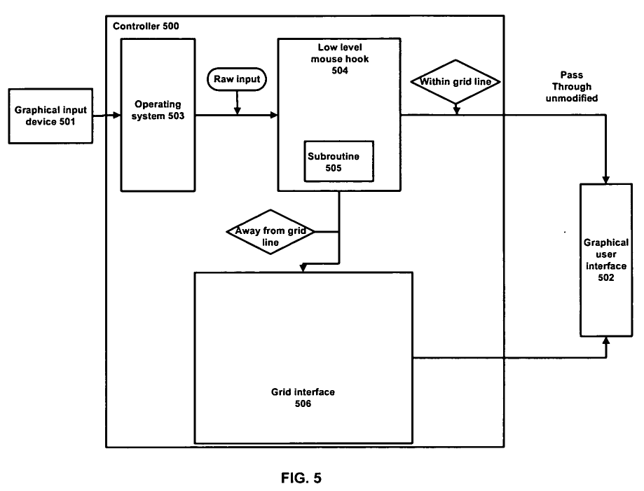

Turning now to FIG. 5, a cursor functionality system is illustrated in block diagram according to another exemplary implementation of the present invention. According to this embodiment, a cursor functionality system comprising one graphical input device is illustrated in the figure herein. However, the system and method described for the invention is not limited to a system with one graphical input device. On the contrary, the invention is intended to cover an interface system utilizing a single or a plurality of graphical input devices. As illustrated in FIG. 5, a cursor functionality system comprising controller 500, graphical input device 501, and graphical user interface 502. Controller 500 accepts inputs from graphical input device 501. Operating system 503 generates raw input and passes raw input to low-level mouse hook 504. Subroutine 505, within low-level mouse hook 504, monitors raw input message. Subroutine 505 determines whether graphical input device 501 is moving along a pre-defined grid line. If graphical input device 501 is moving along a pre-defined grid line, raw input messages will pass through unmodified and reaches the target window procedure. For example, it will be used to generate a cursor or control point via the graphical user interface 502. If subroutine 505 determines graphical input device 501 is not moving along a pre-defined grid line, subroutine 505 calls a movement adjustment function and generates grid application 506 via graphical user interface 502. Grid application 506 restricts the movement of cursor or control point generated by graphical input device 501 to a pre-defined grid line.

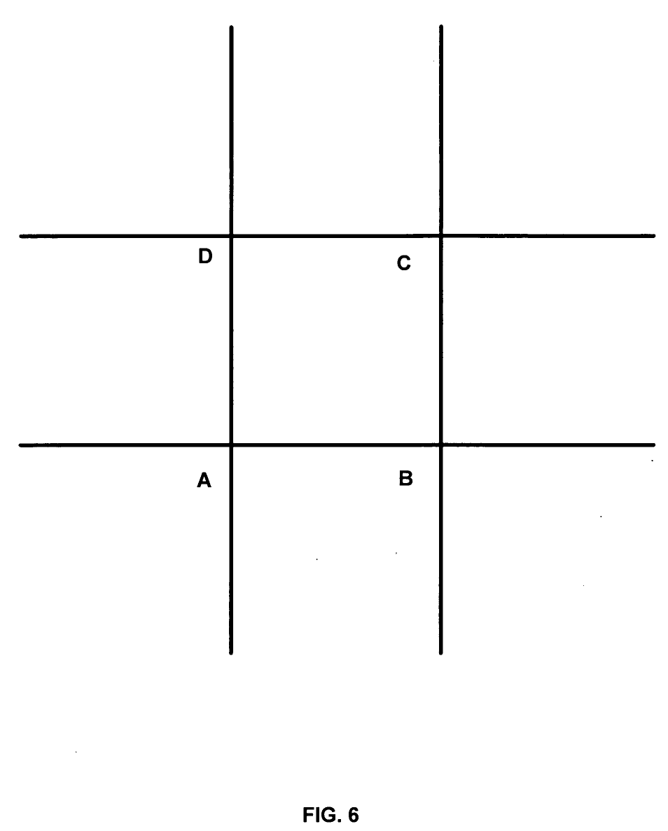

FIG. 6 is a diagrammatic illustration of a pre-defined grid line comprising AB, BC, CD, and DA. When cursor or control point generated by graphical input device 501 is moving according to this pre-defined grid line, e.g. from A to B, subroutine 206 does not call a movement adjustment function, and raw input message passes through unmodified. When cursor or control point generated by graphical input device 501 is moving away from this pre-defined grid line, e.g. from A to C, subroutine 206 calls a movement adjustment function and processes the raw input message under grid application 506. Grid application 506 restricts the movement of cursor or control point generated by graphical input device 501 to a pre-defined grid line, e.g. from A to B, and then to C. It would be obvious to a person skilled in the art that other pre-defined grid lines could be adopted for the system described herein.

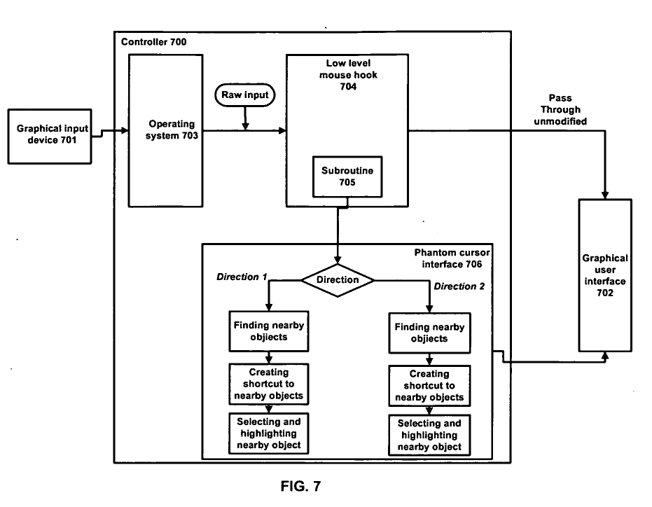

Turning now to FIG. 7, a cursor functionality system is illustrated in block diagram according to another exemplary implementation of the present invention. According to this embodiment, a cursor functionality system comprising one graphical input device is illustrated in the figure herein. However, the system and method described for the invention is not limited to a system with one graphical input device. On the contrary, the invention is intended to cover an interface system utilizing a single or a plurality of graphical input devices. Illustrated in FIG. 7 is a cursor functionality system comprising controller 700, graphical input device 701, and graphical user interface 702. Controller 700 accepts inputs from graphical input device 701. Operating system 703 generates raw input and passes raw input to low-level mouse hook 704. Subroutine 705, within low-level mouse hook 704, monitors raw input messages. Raw input messages pass through unmodified for generating system cursor or control point via graphical user interface 702. Upon receiving raw input message, subroutine 505 generates Phantom Cursor interface 706 via graphical user interface 702. According to the position and movement of the cursor or control point, subroutine 505 generates Phantom Cursor interface 706 via graphical user interface 702 in response to the position and movement of the cursor or control point. Based on the position of the cursor or control point, objects within a single or a plurality of pre-selected definitions, such as icons, menu bars, etc., are selected and highlighted within Phantom Cursor interface 706. Based on the movement of the cursor and control point, objects within a single or a plurality of pre-selected definitions are selected and highlighted in different modes. If the cursor or control point is moving along a vertical direction (up-down), the Phantom Cursor interface 706 selects and highlights objects within a single or a plurality of pre-selected definitions, and the selection and highlight move from object to object in a vertical direction in response to cursor movement. If the cursor or control point is moving along a horizontal direction (left-right), the Phantom Cursor interface 706 selects and highlights objects within a single or a plurality of pre-selected definitions, and the selection and highlight move from object to object in a horizontal direction in response to cursor movement. Examples of pre-selected definitions include, but are not limited to, a single or a plurality of pre-selected definitions, a pre-defined icon or button, a pre-defined function within an application, a pre-defined object, etc. It would be obvious to a person skilled in the art that various alternative pre-selected definitions can be defined by users.

Preferably, cursor or control point overrides actions by the Phantom Cursor interface. The selections and highlights by Phantom Cursor interface can be activated under certain predefined circumstances. For example, Phantom Cursor interface can be activated by holding the control key, and by clicking the button on graphical input device. It would be obvious to a person skilled in the art that various alternative methods can be used to activate the Phantom Cursor interface activities.

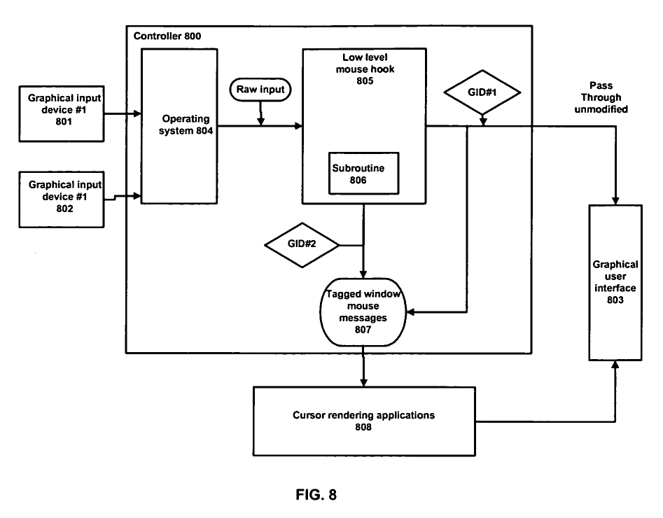

Turning now to FIG. 8, a cursor functionality system is illustrated in block diagram according to one exemplary implementation of the present invention. According to this embodiment, a cursor functionality system comprising two graphical input devices is illustrated in the figure herein. However, the system and method described for the invention is not limited to a system with two graphical input devices. On the contrary, the invention is intended to cover an interface system utilizing a single or a plurality of graphical input devices. Illustrated in FIG. 8 is a cursor functionality system comprising controller 800, graphical input device # 1 801, graphical input device # 2 802, and graphical user interface 803. Controller 800 accepts inputs from graphical input device # 1 801 and graphical input device # 2 802. Operating system 804 generates raw input and passes raw input to low-level mouse hook 805. Subroutine 806, within low level mouse hook 805, monitors raw input messages. Subroutine 806 determines which graphical input device generates the raw input message. If raw input message is generated by graphical input device #1 801, it will pass through unmodified and reach the target window procedure. For example, it will be used to generate a cursor or control point via the graphical user interface 803. Subroutine 806 determines that a raw input message is generated by either graphical input device #1 801 or graphical input device #2 802; subroutine 806 generates tagged window mouse messages 807 corresponding to specific graphical input devices 801 or 802.

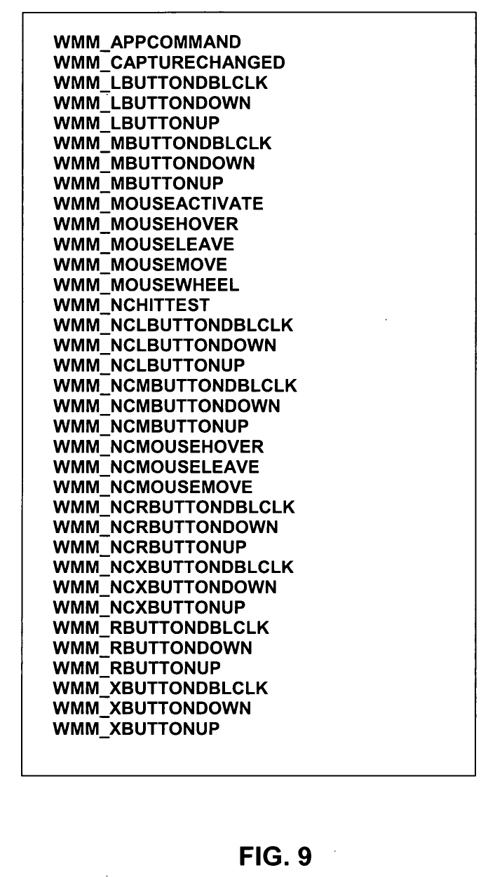

Tagged window mouse messages 807 comprise messages describing mouse functions. As understood herein, the term “tagged window mouse messages” is interpreted and construed broadly to mean newly generated mouse messages by subroutine 806 to mirror the functionality of the standard windows mouse messages. It would be obvious to a person skilled in the art that such tagged window mouse messages can be tagged with a unique label, e.g. “WMM_”. As illustrated in FIG. 9, examples of such tagged messages include, but are not limited to: WMM_APPCOMMAND, WMM_CAPTURECHANGED, WMM_LBUTTONDBLCLK, WMM_LBUTTONDOWN, WMM_LBUTTONUP, WMM_MBUTTONDBLCLK, WMM_MBUTTONDOWN, WMM_MBUTTONUP, WMM_MOUSEACTUVATE, WMM_MOUSEHOVER, WMM_MOUSELEAVE, WMM_MOUSEMOVE, WMM_MOUSEWHEEL, WMM_NCHITTEST, WMM_NCLBUTTONDBLCLK, WMM_NCLBUTTONDOWN, WMM_NCLBUTTONUP, WMM_NCMBUTTONDBLCLK, WMM_NCMBUTTONDOWN, WMM_NCMBUTTONUP, WMM_NCMOUSEHOVER, WMM_NCMOUSELEAVE, WMM_NCMOUSEMOVE, WMM_NCRBUTTONDBLCLK, WMM_NCRBUTTONDOWN, WMM_NCRBUTTONUP, WMM_NCXBUTTONDBLCLK, WMM_NCXBUTTONDOWN, WMM_NCXBUTTONUP, WMM_RBUTTONDBLCLK, WMM_RBUTTONDOWN, WMM_RBUTTONUP, WMM_XBUTTONDBLCLK, WMM_XBUTTONDOWN, WMM_XBUTTONUP.

As illustrated in FIG. 8, tagged window mouse messages 807 can be used by cursor rendering applications 808 to generate a single or a plurality of cursors or control points via graphical user interface 803. Systems and methods for cursor rendering applications 808 are described in U.S. patent application Ser. No. 11/001,328, filed Nov. 30, 2004, entitled “IMPROVED COMPUTER INTERFACE SYSTEM USING MULTIPLE INDEPENDENT GRAPHICAL DATA INPUT DEVICES”, by James Fairs, Vlad Zarney, and Daniel E. Schaaf.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of invention shall not be limited by this Detailed Description, but rather by Claims following.

What is claimed:

1. A computer-implemented method for improved cursor functionality, comprising the steps of:
accepting inputs from a single or a plurality of graphical input devices;
converting inputs from said graphical input devices into raw input messages; and
monitoring said raw input messages within low-level mouse hook, wherein a single or a plurality of subroutines resides within said low-level mouse hook;
wherein said subroutine determines which said graphical input device generates said raw input message.

2. A method as in claim 1, wherein one of said graphical input devices is designated as the primary graphical input device, and any raw input message generated from said primary graphical input device passes through said low-level mouse hook unmodified.

3. A method as in claim 2, wherein said subroutine calls a direction function whenever any raw input message generated from any non-primary graphical input device is read and monitored by said low-level mouse hook, said subroutine generates an interface.

4. A method as in claim 3, wherein said subroutine generates first interface when movement of said non-primary graphical input device is along first pre-defined direction, said subroutine generates second interface when movement of said non-primary graphical input device is along second pre-defined direction.

5. A method as in claim 4, wherein said first pre-defined direction is dominantly horizontal.

6. A method as in claim 4, wherein said second pre-defined direction is dominantly vertical.

7. A method as in claim 4, wherein said first interface provides a shortcut to various application programs.

8. A method as in claim 4, wherein said second interface provides a shortcut to various actions to be preformed within an application program in use.

9. A computer-implemented method for improved cursor functionality, comprising the following steps:
accepting inputs from a single or a plurality of graphical input devices;
converting inputs from said graphical input devices into raw input messages; and
monitoring said raw input messages within low-level mouse hook, wherein a single or a plurality of subroutines reside within said low-level mouse hook;
wherein said subroutine determines which said graphical input device generates said raw input message;
wherein one of said graphical input devices is designated as primary graphical input device, raw input message generated from said primary graphical input device passes through said low-level mouse hook unmodified;
wherein said subroutine calls a direction function whenever raw input message generated from non-primary graphical input device is read and monitored by said low-level mouse hook, said subroutine generates an interface;
wherein said subroutine generates first interface when movement of said non-primary graphical input device is dominantly horizontal, said subroutine generates second interface when movement of said non-primary graphical input device is dominantly vertical;
wherein said first interface provides a shortcut to various application programs, said second interface provides a shortcut to various actions to be performed within an application program in use.

10. A computer-implemented method for improved cursor functionality, comprising the steps of:
accepting inputs from a single or a plurality of graphical input devices;
converting inputs from said graphical input devices into raw input messages; and
monitoring said raw input messages within low-level mouse hook, wherein a single or a plurality of subroutines reside within said low-level mouse hook;
wherein said subroutine determines whether said graphical input device moves along a single or a plurality of pre-defined grid lines.

11. A method as in claim 10, wherein said raw input message passes through said low-level mouse hook unmodified if said graphical input device moves along said pre-defined grid line.

12. A method as in claim 11, wherein said subroutine calls a movement adjustment function whenever said graphical input device moves along said pre-defined grid line, said subroutine generates an interface.

13. A method as in claim 12, wherein said interface restricts the movement of cursor or control point generated by said graphical input device to said pre-defined grid line.

14. A method as in claim 13, wherein said pre-defined grid line comprises horizontal and vertical grid lines.

15. A computer-implemented method for improved cursor functionality, comprising the following steps:
accepting inputs from a single or a plurality of graphical input devices;
converting inputs from said graphical input devices into raw input messages; and
monitoring said raw input messages within low-level mouse hook, wherein a single or a plurality of subroutines reside within said low-level mouse hook;
wherein said subroutine generates an interface to select and highlight objects surrounding system cursor or control point generated by said graphical input device.

16. A method as in claim 15, wherein said objects are selected and highlighted within a single or a plurality of pre-selected definitions.

17. A method as in claim 16, wherein said interface selects and highlights said objects in response to the movement of said graphical input device.

18. A method as in claim 17, wherein said system cursor or control point overrides actions by said interface, said actions by said interface are activated under pre-defined circumstance.

19. An electronic device for implementing improved cursor functionality, comprising:
a single or a plurality of data processors, said data processors operating in accordance with a stored program;
a single or a plurality of memories, wherein said memory stores said digital image;
a single or a plurality of graphical user interfaces, wherein said graphical user interface displays said digital image;
wherein said memory further comprises a single or a plurality of operating systems, said memory further comprises a single or a plurality of low-level mouse hooks;
wherein a single or a plurality of subroutines reside within said low-level mouse hook;
wherein said operating system accepts inputs from a single or a plurality of graphical input devices, said operating system converts inputs from said graphical input devices into raw input messages;
wherein said low-level mouse hook monitors said raw input messages;
wherein said subroutine determines which said graphical input device generates said raw input message.

20. An electronic device as in claim 19, wherein one of said graphical input devices is designated as primary graphical input device, raw input message generated from said primary graphical input device passes through said low-level mouse hook unmodified.

21. An electronic device as in claim 20, wherein said subroutine calls a direction function whenever raw input message generated from non-primary graphical input device is read and monitored by said low-level mouse hook, said subroutine generates an interface.

22. An electronic device as in claim 21, wherein said subroutine generates first interface when movement of said non-primary graphical input device is along first pre-defined direction, said subroutine generates second interface when movement of said non-primary graphical input device is along second pre-defined direction.

23. An electronic device as in claim 22, wherein said first pre-defined direction is dominantly horizontal.

24. An electronic device as in claim 22, wherein said second pre-defined direction is dominantly vertical.

25. An electronic device as in claim 22, wherein said first interface provides a shortcut to various application programs.

26. An electronic device as in claim 22, wherein said second interface provides a shortcut to various actions to be performed within an application program in use.

27. An electronic device for implementing improved cursor functionality, comprising:
a single or a plurality of data processors, said data processors operating in accordance with a stored program;
a single or a plurality of memories, wherein said memory stores said digital image;
a single or a plurality of graphical user interfaces, wherein said graphical user interface displays said digital image;
wherein said memory further comprises a single or a plurality of operating systems, said memory further comprises a single or a plurality of low-level mouse hooks;
wherein a single or a plurality of subroutines reside within said low-level mouse hook;
wherein said operating system accepts inputs from a single or a plurality of graphical input devices, said operating system converts inputs from said graphical input devices into raw input messages;
wherein said low-level mouse hook monitors said raw input messages;
wherein said subroutine determines which said graphical input device generates said raw input message;
wherein one of said graphical input devices is designated as primary graphical input device, raw input message generated from said primary graphical input device passes through said low-level mouse hook unmodified;
wherein said subroutine calls a direction function whenever raw input message generated from non-primary graphical input device is read and monitored by said low-level mouse hook, said subroutine generates an interface;
wherein said subroutine generates first interface when movement of said non-primary graphical input device is dominantly horizontal, said subroutine generates second interface when movement of said non-primary graphical input device is dominantly vertical;
wherein said first interface provides a shortcut to various application programs, said second interface provides a shortcut to various actions to be performed within an application program in use.

28. An electronic device for implementing improved cursor functionality, comprising:
a single or a plurality of data processors, said data processors operating in accordance with a stored program;
a single or a plurality of memories, wherein said memory stores said digital image;
a single or a plurality of graphical user interfaces, wherein said graphical user interface displays said digital image;
wherein said memory further comprises a single or a plurality of operating systems, said memory further comprises a single or a plurality of low-level mouse hooks;
wherein a single or a plurality of subroutines reside within said low-level mouse hook;
wherein said operating system accepts inputs from a single or a plurality of graphical input devices, said operating system converts inputs from said graphical input devices into raw input messages;
wherein said low-level mouse hook monitors said raw input messages;
wherein said subroutine determines whether said graphical input device moves along a single or a plurality of pre-defined grid lines.

29. An electronic device as in claim 28, wherein said raw input message passes through said low-level mouse hook unmodified if said graphical input device moves along said pre-defined grid line.

30. An electronic device as in claim 29, wherein said subroutine calls a movement adjustment function whenever said graphical input device moves along said pre-defined grid line, said subroutine generates an interface.

31. An electronic device as in claim 30, wherein said interface restricts the movement of cursor or control point generated by said graphical input device to said pre-defined grid line.

32. An electronic device as in claim 31, wherein said pre-defined grid line comprises horizontal and vertical grid lines.

33. An electronic device for implementing improved cursor functionality, comprising:
a single or a plurality of data processors, said data processors operating in accordance with a stored program;
a single or a plurality of memories, wherein said memory stores said digital image;
a single or a plurality of graphical user interfaces, wherein said graphical user interface displays said digital image;
wherein said memory further comprises a single or a plurality of operating systems, said memory further comprises a single or a plurality of low-level mouse hooks;
wherein a single or a plurality of subroutines reside within said low-level mouse hook;
wherein said operating system accepts inputs from a single or a plurality of graphical input devices, said operating system converts inputs from said graphical input devices into raw input messages;
wherein said low-level mouse hook monitors said raw input messages;
wherein said subroutine generates an interface to select and highlight objects surrounding system cursor or control point generated by said graphical input device.

34. An electronic device as in claim 33, wherein said objects are selected and highlighted within a single or a plurality of pre-selected definitions.

35. An electronic device as in claim 34, wherein said interface selects and highlights said objects in response to the movement of said graphical input device.

36. An electronic device as in claim 35, wherein said system cursor or control point overrides actions by said interface, said actions by said interface are activated under pre-defined circumstance.

37. An article of manufacture comprising medium storing instructions that causes a processor-based system to:
accept inputs from a single or a plurality of graphical input devices;
convert inputs from said graphical input devices into raw input messages;
monitor said raw input messages within low-level mouse hook, wherein a single or a plurality of subroutines reside within said low-level mouse hook;
wherein said subroutine determines which said graphical input device generates said raw input message.

38. An article of manufacture as in claim 37, wherein one of said graphical input devices is designated as primary graphical input device, raw input message generated from said primary graphical input device passes through said low-level mouse hook unmodified.

39. An article of manufacture as in claim 38, wherein said subroutine calls a direction function whenever raw input message generated from non-primary graphical input device is read and monitored by said low-level mouse hook, said subroutine generates an interface.

40. An article of manufacture as in 39, wherein said subroutine generates first interface when movement of said non-primary graphical input device is along first pre-defined direction, said subroutine generates second interface when movement of said non-primary graphical input device is along second pre-defined direction.

41. An article of manufacture as in claim 40, wherein said first pre-defined direction is dominantly horizontal.

42. An article of manufacture as in claim 40, wherein said second pre-defined direction is dominantly vertical.

43. An article of manufacture as in claim 40, wherein said first interface provides a shortcut to various application programs.

44. An article of manufacture as in claim 40, wherein said second interface provides a shortcut to various actions to be preformed within an application program in use.

45. An article of manufacture comprising medium storing instructions that causes a processor-based system to:
accept inputs from a single or a plurality of graphical input devices;
convert inputs from said graphical input devices into raw input messages;
monitor said raw input messages within low-level mouse hook, wherein a single or a plurality of subroutines reside within said low-level mouse hook;
wherein said subroutine determines which said graphical input device generates said raw input message;
wherein one of said graphical input devices is designated as primary graphical input device, raw input message generated from said primary graphical input device passes through said low-level mouse hook unmodified;
wherein said subroutine calls a direction function whenever raw input message generated from non-primary graphical input device is read and monitored by said low-level mouse hook, said subroutine generates an interface;
wherein said subroutine generates first interface when movement of said non-primary graphical input device is dominantly horizontal, said subroutine generates second interface when movement of said non-primary graphical input device is dominantly vertical;
wherein said first interface provides a shortcut to various application programs, said second interface provides a shortcut to various actions to be preformed within an application program in use.

46. An article of manufacture comprising medium storing instructions that causes a processor-based system to:
accept inputs from a single or a plurality of graphical input devices;
convert inputs from said graphical input devices into raw input messages;
monitor said raw input messages within low-level mouse hook, wherein a single or a plurality of subroutines reside within said low-level mouse hook;
wherein said subroutine determines whether said graphical input device moves along a single or a plurality of pre-defined grid lines.

47. An article of manufacture as in claim 46, wherein said raw input message passes through said low-level mouse hook unmodified if said graphical input device moves along said pre-defined grid line.

48. An article of manufacture as in claim 47, wherein said subroutine calls a movement adjustment function whenever said graphical input device moves along said pre-defined grid line, said subroutine generates an interface.

49. An article of manufacture as in claim 48, wherein said interface restricts the movement of cursor or control point generated by said graphical input device to said pre-defined grid line.

50. A method as in claim 49, wherein said pre-defined grid line comprises horizontal and vertical grid lines.

51. An article of manufacture comprising medium storing instructions that causes a processor-based system to:
accept inputs from a single or a plurality of graphical input devices;
convert inputs from said graphical input devices into raw input messages;
monitor said raw input messages within low-level mouse hook, wherein a single or a plurality of subroutines reside within said low-level mouse hook;
wherein said subroutine generates an interface to select and highlight objects surrounding system cursor or control point generated by said graphical input device.

52. An article of manufacture as in claim 51, wherein said objects are selected and highlighted within a single or a plurality of pre-selected definitions.

53. An article of manufacture as in claim 52, wherein said interface selects and highlights said objects in response to the movement of said graphical input device.

54. An article of manufacture as in claim 53, wherein said system cursor or control point overrides actions by said interface, said actions by said interface are activated under pre-defined circumstance.

55. A computer-implemented method for improved cursor functionality, comprising the following steps:
accepting inputs from a single or a plurality of graphical input devices;
converting inputs from said graphical input devices into raw input messages;
monitoring said raw input messages within low-level mouse hook, wherein a single or a plurality of subroutines reside within said low-level mouse hook;
wherein said subroutine generates tagged windows mouse messages.

56. A method as in claim 55, wherein said tagged window mouse messages are used as inputs for a single or a plurality of cursor rendering applications.

57. An electronic device for implementing improved cursor functionality, comprising:
a single or a plurality of data processors, said data processors operating in accordance with a stored program.
a single or a plurality of memories, wherein said memory stores said digital image;
a single or a plurality of graphical user interfaces, wherein said graphical user interface displays said digital image;
wherein said memory further comprises a single or a plurality of operating systems, said memory further comprises a single or a plurality of low-level mouse hooks;
wherein a single or a plurality of subroutines reside within said low-level mouse hook;
wherein said operating system accepts inputs from a single or a plurality of graphical input devices, said operating system converts inputs from said graphical input devices into raw input messages;
wherein said low-level mouse hook monitors said raw input messages;
wherein said subroutine generates tagged windows mouse messages.

58. An electronic device as in claim 57, wherein said tagged window mouse messages are used as inputs for a single or a plurality of cursor-rendering applications.

59. An article of manufacture comprising medium storing instructions that causes a processor-based system to:
accept inputs from a single or a plurality of graphical input devices;
convert inputs from said graphical input devices into raw input messages;
monitor said raw input messages within low-level mouse hook, wherein a single or a plurality of subroutines reside within said low-level mouse hook;
wherein said subroutine generates tagged windows mouse messages.

60. An article of manufacture as in claim 59, wherein said tagged window mouse messages are used as inputs for a single or a plurality of cursor-rendering applications.
